(19) United States
(12) Patent Application Publication
(10) Pub. No.: US 2015/0118020 A1
(43) Pub. Date: Apr. 30, 2015

(54) POWER GENERATION SYSTEM

(71) Applicant: CHENG FU CHIU, TAIPEI CITY (TW)

(72) Inventor: CHENG FU CHIU, TAIPEI CITY (TW)

(21) Appl. No.: 14/341,980

(22) Filed: Jul. 28, 2014

(30) Foreign Application Priority Data
Oct. 30, 2013 (TW) 102220204

(51) Int. Cl. F03D 9/00; F03D 1/06; F03B 13/10; F03B 3/04

(52) U.S. Cl. CPC F03D 9/002; F03B 3/04; F03D 1/06; F03B 13/10
USPC 415/4.1

(57) ABSTRACT

A power generation system includes a generator and a rotary mechanism. The rotary mechanism includes a rotary shaft rotatably connected to the generator and at least one drive module connected with the rotary shaft. The drive module has a flow collection hood. The flow collection hood has a hood body and a flow direction control unit. The hood body defines a front opening and a rear opening and has a peripheral wall positioned between the front and rear openings. The flow direction control unit is disposed on the hood body. The flow direction control unit serves to block and interrupt a fluid flowing from the front opening to the rear opening, while permitting a fluid flowing from the rear opening to the front opening to freely flow through the hood body, whereby the drive module is drivable by the fluid to drive the rotary shaft to one-way rotate.

### BACKGROUND OF THE INVENTION

1. Field of the Invention

The present invention relates generally to a power generation system, and more particularly to a power generation system drivable by a fluid to provide mechanical energy and further convert the mechanical energy into electrical energy.

2. Description of the Related Art

In general, a conventional power generation system generates power via a fixed medium. For example, a wind power generator is driven by wind to provide mechanical energy, while a hydraulic power generation system is driven by sea flow or ocean flow to provide mechanical energy and further convert the mechanical energy into electrical energy. Therefore, the power generation systems on the ground and under the sea generally have different drive apparatuses with different structures for providing mechanical energy.

Please refer to FIG. 1. a prior art discloses a wind power drive apparatus. The wind power drive apparatus includes a base 3, a support 4, a transmission shaft 5 and an impeller structure 6. The impeller structure 6 includes a main body 61 and at least one blade 62 connected with the main body 61. The blade 62 has a frame 621, at least one one-way flap 622 and at least one movable stopper board 623. The frame 621 is a hollow frame body. The movable stopper board 623 serves to elastically stop and restrict the one-way flap 622. The support 4 is a hollow tubular body disposed on the base 3. The transmission shaft 5 extends through the support 4. One end of the transmission shaft 5 is connected with the main body 61 of the impeller structure 6 to pivotally dispose the impeller structure 6 on the support 4, whereby the mechanical power can be output from the transmission shaft 5. A generator 7 is disposed on the base 3. The other end of the transmission shaft 5 is connected with an input end of the generator 7. According to the arrangement of the wind power drive apparatus, when the blade 62 of the impeller structure 6 is driven by wind to generate mechanical energy, the transmission shaft 5 is driven and rotated via the main body 61, whereby the generator 7 is driven to generate electrical power.

The blade 62 of the above patent has a plane structure, which can hardly collect fluid. Only the wind (forward wind) that directly flows toward the blade 62 can push and drive the blade 62. In case that the forward wind is weak, it is impossible to push the blade 62. In other words, a greater forward wind power is needed for pushing the blade 62. Moreover, it is necessary to adjust the angle of the blade 62 according to the direction of the wind so as to provide larger windward area and enhance the wind drive effect. Such structure is inapplicable to hydraulic drive system.

### SUMMARY THE INVENTION

It is therefore a primary object of the present invention to provide a power generation system, which can collect fluid to increase the drive force. Moreover, the power generation system is applicable to both airflow drive and water flow drive system.

To achieve the above and other objects, the power generation system of the present invention includes a generator for converting mechanical energy into electrical energy and a rotary mechanism for generating mechanical energy. The rotary mechanism includes a rotary shaft rotatably connected to the generator and at least one drive module connected with the rotary shaft. The drive module has a flow collection hood. The flow collection hood has a hood body and a flow direction control unit. The hood body defines a front opening and a rear opening and has a peripheral wall positioned between the front and rear openings. The flow direction control unit is disposed on the hood body. The flow direction control unit serves to block and interrupt a fluid flowing from the front opening to the rear opening, while permitting a fluid flowing from the rear opening to the front opening to freely flow through the hood body so as to achieve a pressure relief effect. Accordingly, the drive module is drivable by the fluid to drive the rotary shaft to one-way rotate for providing mechanical energy.

In the above power generation system, the flow direction control unit is disposed on the peripheral wall of the hood body between the front and rear openings or disposed at the rear opening of the hood body.

In the above power generation system, the flow direction control unit has multiple partitioning beams disposed on the hood body to longitudinally and transversely intersect each other. The partitioning beams partition the hood body into at least one passage. The flow direction control unit further has at least one movable flap corresponding to the passage. The movable flap is pivotally rotatable toward an interior of the hood body to one-way unblock the passage.

In the above power generation system, the partitioning beams are tapered from a front side proximal to the front opening to a rear side proximal to the rear opening, whereby a resistance against the fluid flowing from the rear opening to the front opening is reduced.

In the above power generation system, the flow direction control unit further has at least one hinge for pivotally connecting the movable flap with the hood body.

In the above power generation system, some of the movable flaps and some of the passages of the hood body are inclined from the hood body.

In the above power generation system, at least some of the movable flaps are equipped with elastic members disposed between the movable flaps and the hood body for elastically forcing the movable flaps to block the passages.

In the above power generation system, each drive module further has at least one connection bar for connecting the flow collection hood to the rotary shaft.

In the above power generation system, the hood body is tapered from the front opening to the rear opening, whereby the front opening is larger than the rear opening.

In the above power generation system, the flow collection hood is funnel-shaped.

In the above power generation system, the generator is installed on a floating carrier on a fluid, the rotary shaft of the generator extending into a fluid under the floating carrier, whereby the drive module is positioned in the fluid.

The present invention is advantageous in that the flow collection hood is able to collect both forward and non-forward fluid. The flow direction control unit is disposed on the hood body to one-way guide the flow. Therefore, not only the forward fluid can be utilized to provide drive force, but also the non-forward fluid can be effectively utilized to increase the drive force. Accordingly, even if the amount of the forward fluid is small, the rotary shafts an still be driven to rotate. Therefore, the mechanical energy can be stably provided for the generator to continuously generate power and increase the yield of electricity. Furthermore, the rotary mechanism is adapted to airflow or water flow drive and can be arranged on the ground or under water, for example, under a sea or a river. Therefore, the application range is widened. The power of the fluid in the nature can be fully utilized to generate power.

The present invention can be best understood through the following description and accompanying drawings, wherein:

### BRIEF DESCRIPTION OF THE DRAWINGS

FIG. 1 is a perspective view of a conventional wind-driven apparatus;

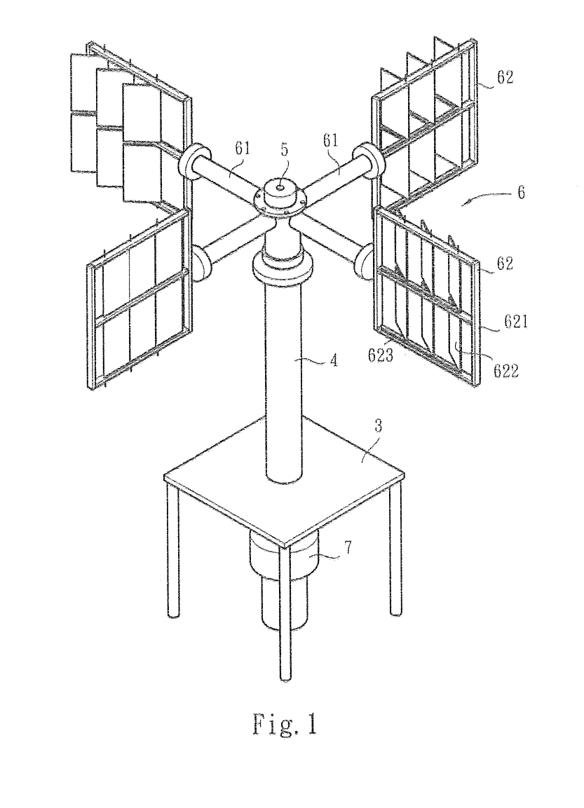

FIG. 2 is a perspective view of a preferred embodiment of the present invention;

FIG. 3 is a perspective view of the flow collection hood of the preferred embodiment of the present invent ion according to FIG. 2;

FIG. 4 is a perspective view of the flow collection hood according to FIG. 3, seen from another angle;

FIG. 5 is a perspective view of another embodiment of the present invention; and

FIG. 6 is a perspective view showing that the present invention is applied to a hydraulic power generation system.

### DETAILED DESCRIPTION OF THE PREFERRED EMBODIMENTS

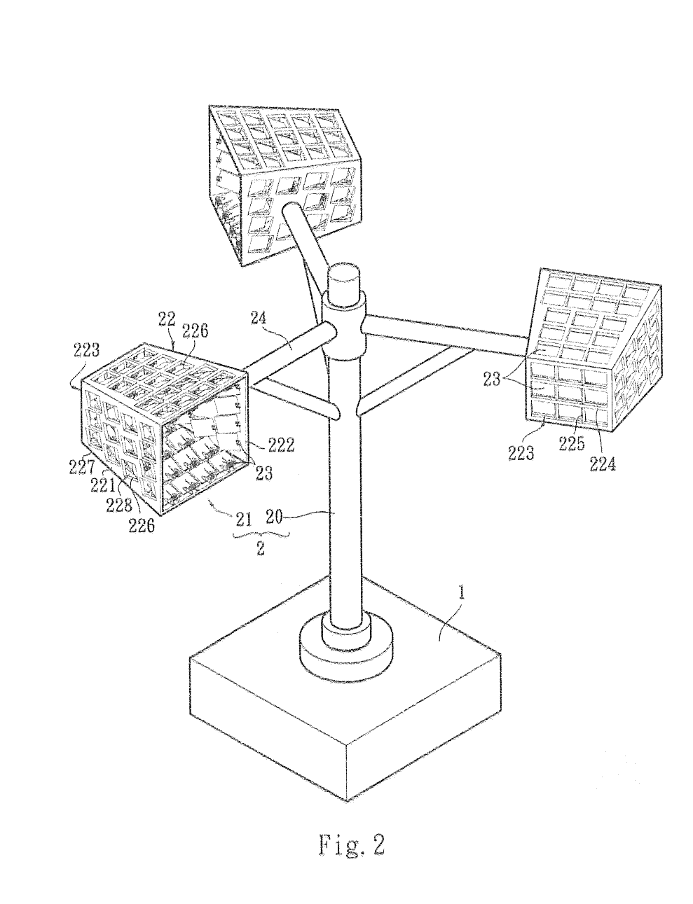

Please refer to FIGS. 2 to 4. The power generation system of the present invention is applicable to a wind power generation system. The power generation system of the present invention includes a generator 1 and a rotary mechanism 2. The generator 1 serves to convert mechanical energy into electrical energy. The generator 1 pertains to prior art and thus will not be further described. The rotary mechanism 2 serves to generate mechanical energy, including a rotary shaft 20 and at least one drive module 21.

As shown in FIG. 2, the rotary shaft 20 is rotatably connected to the generator 1. In this embodiment, the generator 1 can be installed on a support lace (not shown) such as the ground. The rotary shaft 20 is upright rotatably disposed on the top section of the generator 1. In this embodiment, there are multiple drive modules 21 connected with the rotary shaft 20 and arranged at intervals. Each drive module 21 has a box-shaped flow collect ion hood 22 and at least one connection bar 24.

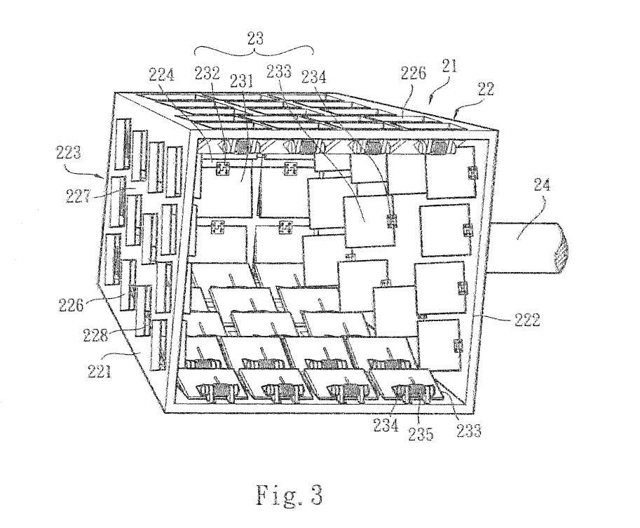

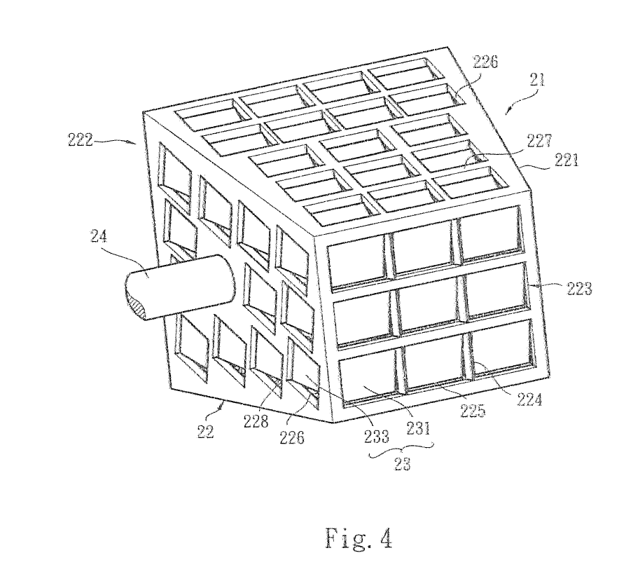

Referring to FIGS. 3 and 4, the flow collection hood 22 has a hood body 221 and a flow direction control unit 23. The connection bar 24 is used to connect the hood body 221 of the flow collection hood 22 and the rotary shaft 20. Two ends of the hood body 221 respectively define a front opening 222 and a rear opening 223 in communication with each other. The hood body 221 has a peripheral wall positioned between the front and rear openings 222, 223. The hood body 221 is tapered from the front opening 222 to the rear opening 223, whereby the front opening 222 has an area larger than that of the rear opening 223. The flow direction control unit 23 is disposed on the hood body 221. The flow direction control unit 23 serves to block and interrupt the fluid flowing from the front opening 222 to the rear opening 223. Also, the flow direction control unit 23 permits the fluid flowing from the roar opening 223 to the front opening 222 to freely flow through the hood body 221 so as to achieve a pressure relief effect.

The flow direction control unit 23 can be disposed at the rear opening 223 of the hood body 221. The flow direction control unit 23 has multiple rear partitioning beams 224 disposed on the hood body 221 to longitudinally and transversely intersect each other. The rear partitioning beams 224 partition the rear opening 223 of the hood body 221 into at least one rear passage 225. In this embodiment, there are multiple rear passages 225. The flow direction control unit 23 further has multiple rear movable flaps 231 correspondingly disposed in the rear passages 225, whereby the rear movable flaps 231 can block the rear passages 225. The flow direct ion control unit 23 further has multiple rear hinges 232 for pivotally connecting the rear movable flaps 231 with the hood body 221. Accordingly, the rear movable flaps 231 can be pivotally rotated toward the interior of the hood body 221 to one-way unblock the rear passages 225.

In addition, the flow direction control unit 23 can be also disposed on the peripheral wall of the hood body 221 between the front and rear openings 222, 223. The peripheral wall of the hood body 221 is formed with multiple lateral openings 226 positioned between the front and rear openings 222, 223. The flow direction control unit 23 has multiple lateral partitioning beams 227 disposed on the hood body 221 to longitudinally and transversely intersect each other. The lateral partitioning beams 227 partition the lateral openings 226 of the hood body 221 into at least one lateral passage 228. In this embodiment, there are multiple lateral passages 228. The flow direction control unit 23 further has multiple lateral movable flaps 233 correspondingly disposed in the lateral passages 228, whereby the lateral movable flaps 233 can block the lateral passages 228. The flow direction control unit 23 further has multiple lateral hinges 234 for pivotally connecting the lateral movable flaps 233 with the hood body 221. Accordingly, the lateral movable flaps 233 can be pivotally rotated toward the interior of the hood body 221 to one-way unblock the lateral passages 228.

In a preferred embodiment, some parts of the hood body 221, such as the lateral movable flaps 233 and the lateral passages 228 on two sides of the hood body 221 can be inclined from the hood body 221. In this case, an angle is contained between the axis of the lateral movable flap 234 and the axis of the rotary shaft 20. Under such circumstance, the lateral movable flaps 233 will block the lateral passages 228 due to its own gravity without being driven by any fluid. At least some parts of the hood body 221, such as the lateral movable flaps 233 of the top face and/or bottom face of the hood body 221 are equipped with elastic members 235 disposed between the lateral movable flaps 233 and the inner wall of the hood body 221. Without being driven by any fluid, the elastic members 235 can elastically force the lateral movable flaps 233 to block the lateral passages 228. In this embodiment, the elastic members 235 can be torque springs disposed on the lateral movable flaps 234.

According to the above arrangement, when a fluid such as an airflow or water flow flows from the front side and/or lateral front side of the front opening 222 into the interior of the hood body 221 toward the rear opening 223, the inner faces of the rear movable flaps 231 of the flow direction control unit 23 are driven by the fluid flowing into the hood body 221 to block the rear passages 225 of the rear opening 223. Under such circumstance, the inner faces of the rear movable flaps 231 of the rear opening 223 serve as forced faces, whereby the fluid applies a force to the forced faces of the rear movable flaps 231 to push the flow collection hood 22.

At the same time, the inner faces of the lateral movable flaps 233 of the flow direction control unit 23 are driven by the fluid in the hood body 221 to block the lateral passages 228 of the lateral openings 226. Under such circumstance, the inner faces of the lateral movable flaps 233 of the lateral openings 223 serve as forced faces, whereby the fluid applies a force to the forced faces of the lateral movable flaps 233 to push the flow collection hood 22.

During this period, the fluid flowing from the front side and/or lateral front side of the front opening 222 to the top face, bottom face or lateral face of the hood body 221 can drive the lateral movable flaps 233 of the top face, bottom face or lateral face to pivotally rotate toward the interior of the hood body 221 so as to unblock the lateral passages 228 of the lateral openings 226. Accordingly, the fluid can flow into the hood body 221. In this case, the resistance against the fluid flowing to the outer walls of the hood body 221 can be eliminated and the fluid flowing to the outer walls of the hood body 221 can be further collected to increase the push force applied to the flow collection hood 22.

The fluid flowing from the front side and lateral front side of the front opening 222 toward the rear opening 223 is defined as a forward fluid. The fluid reverse to the forward fluid is defined as a backward fluid. When the drive modules 21 encounter the backward fluid, the rear movable flaps 231 and some lateral movable flaps 233 of the flow direction control unit 23 are driven by the backward fluid to unblock the rear passages 225 of the rear opening 223 and the lateral passages 228 of the lateral openings 226. Accordingly, the backward fluid will flow through the rear passages 225 and the lateral passages 228 into the hood body 221 to flow out from the front opening 222. This can reduce the resistance against rotation of the flow collection hood 22 and limit the flow collection hood 22 to only one-way rotate around the rotary shaft 20.

In a preferred embodiment, the rear partitioning beams 224 of the hood body 221 are tapered from a front side proximal to the front opening 222 to a rear side proximal to the rear opening 223. In this case, the resistance against the backward fluid flowing from the roar opening 223 to the front opening 222 is reduced. The lateral partitioning beams 227 are tapered from the interior of the hood body 221 to the exterior of the hood body 221. In this case, the resistance against the backward fluid flowing from outer side of the hood body 221 to the inner side of the hood body 221 is reduced. Also, the hood body 221 is tapered from the front opening 222 to the rear opening 223 to reduce the resistance against the backward fluid.

Accordingly, the drive modules 21 are drivable by the fluid to drive the rotary shaft 20 to one-way rotate, whereby the generator 1 can convert the mechanical energy into electrical energy.

It should be noted that the hood body 221 has at surrounding wall face. Therefore, the fluid that indirectly flows to the forced faces of the rear movable flaps 231 can collide with the well face of the hood body 221 and then flow to the forced faces of the rear movable flaps 231. When colliding with the wall face of the hood body 221, a component force normal to the forced faces of the rear movable flaps 231 is applied to the hood body 221. In this case, even if the amount of the fluid directly flowing toward the forced faces of the rear movable flaps 231 is small, the fluid that indirectly flows to the forced faces of the rear movable flaps 231, (for example, the fluid that flows from the lateral front side of the front opening 222 toward the rear opening 223) can be utilized to increase the drive force, whereby the rotary shaft 20 can stably rotate. That is, only with a certain amount of fluid flowing around the hood body 221, the flow collection hood 22 can be driven to drive and rotate the rotary shaft 20.

In addition, each drive module 21 can have two connection bars 24 for connecting the hood body 221 of the flow collection hood 22 to the rotary shaft 20 to provide greater support force. Alternatively, each drive module 21 can have only one connection bar 24 for connecting the hood body 221 of the flow collection hood 22 to the rotary shaft 20.

Moreover, the rear opening 223 of the hood body 221 is partitioned by the longitudinally and transversely intersecting rear partitioning beams 224 into multiple rear passages 225. The rear movable flaps 231 can one-way block the rear passages 225 to reduce the resistance against the backward fluid. The area of the rear movable flap 231 is smaller so that the rear movable flap 231 can be more mobilely pivotally rotated to lower the possibility of damage. Alternatively, the rear opening 223 of the hood body 221 is not partitioned and only one single large-area rear movable flap is disposed at the rear opening 223 to one-way block the same. Still alternatively, the rear opening 223 can be partitioned only by longitudinal or transverse rear partitioning beams 224 arranged at intervals. Similarly, the lateral partitioning beams 227, the lateral passages 228 and the lateral movable flaps 233 can be arranged in a form as the rear partitioning beams 224, the rear passages 225 and the rear movable flaps 231.

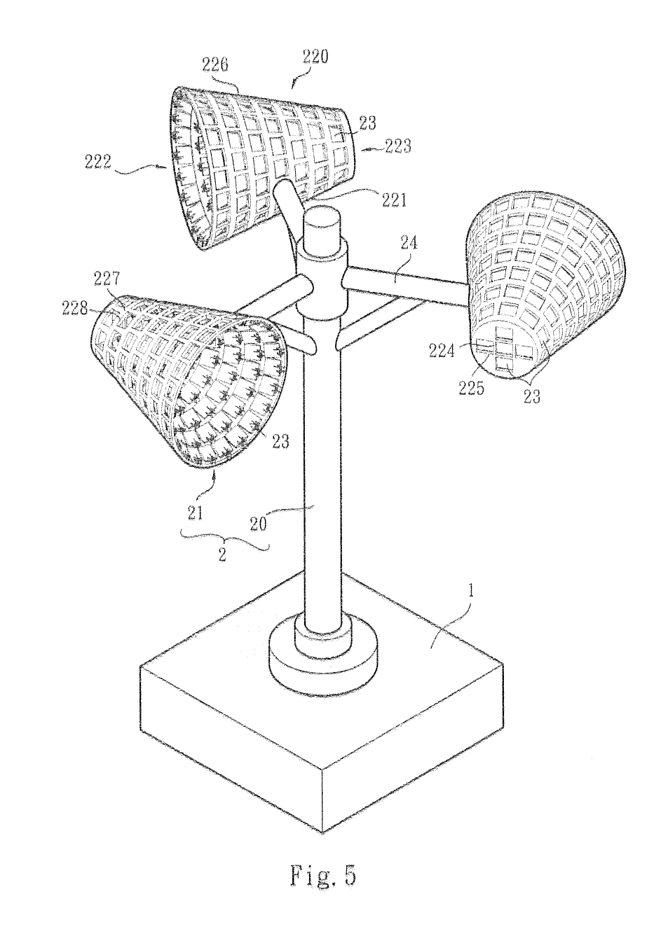

Please now refer to FIG. 5. In another embodiment, the flow collection hood 220 has the form of a funnel. The funnel-shaped flow collection hood 220 can reduce the resistance against the backward fluid. The components and the application of this embodiment are identical to that of the above embodiment.

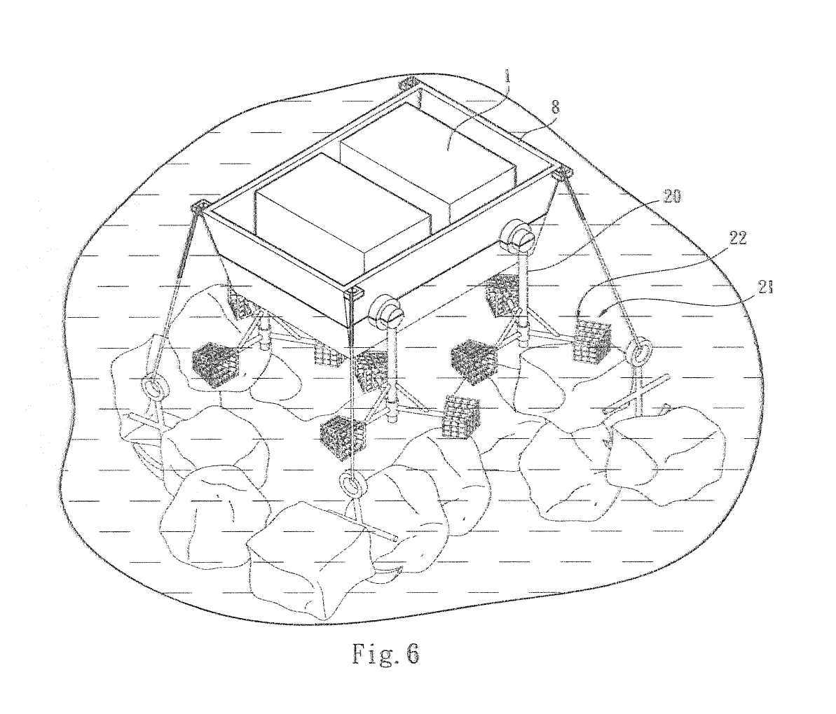

Please now refer to FIG. 6, which shows that the present invention is applied to a hydraulic power generation system. The generator 1 can be installed on a floating carrier 8 on a fluid. The floating carrier 8 is a carrier body that can float on water and is concrete enough to carry the generator 1, such as a boat or a floater. The generator 1 can be laterally connected with two rotary shafts 20. The rotary shafts 20 transversely extend through the floating carrier 8 and then turn to lower side of the floating carrier 8 into the fluid. Accordingly, the multiple drive modules 21 are positioned in the fluid under the floating carrier 8. In this case, the floating carrier 8 can be placed on a sea face, a lake face or a river face and anchored on the rocks in the water. All the rotary shafts 20 extend into the water to immerse the drive modules 21 into the water. Under such circumstance, the flow collection hoods 22 can be driven by water flow to drive and rotate the rotary shafts 20. The components and application of this embodiment are identical to that of the above embodiment.

According to the above arrangement, each drive module 21 has a flow collection hood 22. Both the forward fluid and non-forward fluid can be utilized to increase the drive force. Especially, in case of smaller amount of forward fluid, the fluid that indirectly flows toward the inner faces of the rear movable flaps 231 can be still utilized to drive and rotate the rotary shafts 20. Therefore, the mechanical energy can be stably provided for the generator 1 to continuously generate power and increase the yield of electricity. Furthermore, the rotary mechanism 2 is adapted to airflow or water flow drive and can be arranged on the ground or under water. Therefore, the application range is widened. The power of the fluid in the nature can be fully utilized to generate power.

The above embodiments are only used to illustrate the present invention, not intended to limit the scope thereof. Many modifications of the above embodiments can be made without departing from the spirit of the present invention.

What is claimed is:

1. A power generation system comprising:
a generator for converting mechanical energy into electrical energy; and
a rotary mechanism for generating mechanical energy, the rotary mechanism including a rotary shaft rotatably connected to the generator and at least one drive module connected with the rotary shaft, the drive module having a flow collection hood, the flow collection hood having a hood body and a flow direction control unit, the hood body defining a front opening and a rear opening and having a peripheral wall positioned between the front and rear openings, the flow direction control unit being disposed on the hood body, the flow direction control unit serving to block and interrupt a fluid flowing from the front opening to the rear opening, while permitting a fluid flowing from the rear opening to the front opening to freely flow through the hood body so as to achieve a pressure relief effect, whereby the drive module is drivable by the fluid to drive the rotary shaft to one-way rotate for providing mechanical energy.

2. The power generation system as claimed in claim 1, wherein the flow direction control unit is disposed on the peripheral wall of the hood body between the front and rear openings.

3. The power generation system as claimed in claim 1, wherein the flow direction control unit is disposed at the rear opening of the hood body.

4. The power generation system as claimed in claim 1, wherein the flow direction control unit has multiple partitioning beams disposed on the hood body to longitudinally and transversely intersect each other, the partitioning beams partitioning the hood body into at least one passage, the flow direction control unit further having at least one movable flap corresponding to the passage, the movable flap being pivotally rotatable toward an interior of the hood body to one-way unblock the passage.

5. The power generation system as claimed in claim 4, wherein the partitioning beams are tapered from a front side proximal to the front opening to a rear side proximal to the rear opening, whereby a resistance against the fluid flowing from the rear opening to the front opening is reduced.

6. The power generation system as claimed in claim 4, wherein the flow direction control unit further has at least one hinge for pivotally connecting the movable flap with the hood body.

7. The power generation system as claimed in claim 4, wherein some of the movable flaps and some of the passages of the hood body are inclined from the hood body.

8. The power generation system as claimed in claim 4, wherein at least some of the movable flaps are equipped with elastic members disposed between the movable flaps and the hood body for elastically forcing the movable flaps to block the passages.

9. The power generation system as claimed in claim 1, wherein each drive module further has at least one connection bar for connecting the flow collection hood to the rotary shaft.

10. The power generation system as claimed in claim 4, wherein each drive modulo further has at least one connection bar for connecting the flow collection hood to the rotary shaft.

11. The power generation system as claimed in claim 8, wherein each drive module further has at least one connection bar for connecting the flow collection hood to the rotary shaft.

12. The power generation system as claimed in claim 1, wherein the hood body is tapered from the front opening to the rear opening, whereby the front opening is larger than the rear opening.

13. The power generation system as claimed in claim 2, wherein the hood body is tapered from the front opening to the rear opening, whereby the front opening is larger than the rear opening.

14. The power generation system as claimed in claim 3, wherein the hood body is tapered from the front opening to the rear opening, whereby the front opening is larger than the rear opening.

15. The power generation system as claimed in claim 4, wherein the hood body is tapered from the front opening to the rear opening, whereby the front opening is larger than the rear opening.

16. The power generation system as claimed in claim 8, wherein the hood body is tapered from the front opening to the rear opening, whereby the front opening is larger than the rear opening.

17. The power generation system as claimed in claim 12, wherein the flow collection hood is funnel-shaped.

18. The power generation system as claimed in claim 15, wherein the flow collection hood is funnel-shaped.

19. The power generation system as claimed in claim 16, wherein the flow collection hood is funnel-shaped.

20. The power generation system as claimed in claim 1, wherein the generator is installed on a floating carrier on a fluid, the rotary shaft of the generator extending into a fluid under the floating carrier, whereby the drive module is positioned in the fluid.

21. The power generation system as claimed in claim 2, wherein the generator is installed on a floating carrier on a fluid, the rotary shaft of the generator extending into a fluid under the floating carrier, whereby the drive module is positioned in the fluid.

22. The power generation system as claimed in claim 3, wherein the generator is installed on a floating carrier on a fluid, the rotary shaft of the generator extending into a fluid under the floating carrier, whereby the drive module is positioned in the fluid.

23. The power general ion system as claimed in claim 8, wherein the generator is installed on a floating carrier on a fluid, the rotary shaft of the generator extending into a fluid under the floating carrier, whereby the drive module is positioned in the fluid.

24. The power generation system as claimed in claim 12, wherein the generator is installed on a floating carrier on a fluid, the rotary shaft of the generator extending into a fluid under the floating carrier, whereby the drive module is positioned in the fluid.
